(19) United States
(12) Patent Application Publication
(10) Pub. No.: US 2022/0036460 A1
(43) Pub. Date: Feb. 3, 2022

(54) Systems and Methods for Asset Analysis

(71) Applicant: Net Profit Advisors, LLC, Greenville, SC (US)

(72) Inventor: Carl M. Stecker, Greenville, SC (US)

(21) Appl. No.: 16/944,527

(22) Filed: Jul. 31, 2020

(51) Int. Cl. G06Q 40/06; G06K 9/62

(52) U.S. Cl. CPC G06Q 40/06; G06K 9/6215; G06K 9/6228; G06K 9/6267

(57) ABSTRACT

Systems and methods for automatic asset analysis are provided. A method can include obtaining user input from a user interface presenting a number of assets. The user input can be indicative of a selected asset from the number of assets. The method can include obtaining an asset profile for the selected asset from a first database and historical data associated with the asset from a second database. The asset profile for the selected asset can be previously generated for the asset based on asset data compiled from a number of external sources. The method can include automatically generating a segregation estimate for the selected asset based on the asset profile and the historical data. The method can include automatically displaying data indicative of the segregation estimate in response to the user input. The specialized user interfaces described herein allow for automatic segregation analysis with minimal user interaction.

### FIELD

The present disclosure relates generally to specialized user interfaces for asset analysis.

### BACKGROUND

Cost Segregation is the process of separating asset components based on their useful class lives for the purpose of justifying enhanced depreciation. Conventional cost segregation estimation techniques require an analysis of an asset's visual characteristics. Such predictions rely on the unique experiences of the estimator thus resulting in a wide range of inaccurate outcomes for a single asset.

### SUMMARY

Aspects and advantages of embodiments of the present disclosure will be set forth in part in the following description, or may be learned from the description, or may be learned through practice of the embodiments.

One example aspect of the present disclosure is directed to a computer-implemented method. The method includes obtaining, by a computing system comprising one or more computing devices, user input indicative of a selected asset from a user. The method includes obtaining, by the computing system, an asset profile for the selected asset from an asset database. The asset database can include asset data associated with a plurality of assets. The asset profile can be previously generated for the selected asset based, at least in part, in the asset data. The method can include obtaining, by the computing system, historical segregation data associated with the selected asset from a historical database. The historical database can include data indicative of a plurality of previous segregation studies for one or more of the plurality of assets. The method can include automatically generating, by the computing system, a holistic segregation estimate for the selected asset based, at least in part, on the asset profile and the historical segregation data. And, the method can include providing for display to the user, by the computing system, the holistic segregation estimate.

Yet another example aspect of the present disclosure is directed to a computing system. The computing system can include an asset database including asset data associated with a plurality of assets and a historical database including historical segregation data indicative of a plurality of previous segregation studies for one or more of the plurality of assets. In addition, the computing system can include one or more display devices, one or more processors, and one or more non-transitory computer-readable media that collectively store instructions that, when executed by the one or more processors, cause the system to perform operations. The operations can include providing for display to a user, via the one or more display devices, a first user interface presenting one or more of the plurality of assets for selection by the user. The operations can include obtaining, via the first user interface, a selection user input indicative of a selected asset. The operations can include obtaining an asset profile for the selected asset from the asset database. The asset profile can be previously generated based, at least in part, on a portion of the asset data corresponding to the selected asset. In response to the selection user input, the operations can include automatically generating a holistic segregation estimate for the selected asset based, at least in part, on the asset profile for the selected asset and the historical segregation data and providing for display to the user, via the one or more display devices, a second user interface presenting at least one of the asset profile or the holistic segregation estimate for the selected asset.

Yet another example aspect of the present disclosure is directed to a computer-implemented method. The method can include obtaining, by a computing system comprising one or more computing devices, search criteria indicative of one or more asset attributes. The method can include providing for display, by the computing system via one or more display devices, a first user interface presenting a visual representation of a plurality of assets for selection by a user. Each of the plurality of assets are associated with the one or more asset attributes. The method can include obtaining, by the computing system via the first user interface, selection user input selecting an asset from the plurality of assets. In response to the selection user input, the method can include automatically generating, by the computing system, a segregation estimate for the asset. And, the method can include storing, by the computing system in an accessible memory, data indicative of the asset and the segregation estimate.

Other examples aspects of the present disclosure are directed to apparatus, methods, electronic devices, non-transitory computer-readable media, and systems. These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example computing system according to example embodiments of the present disclosure;

FIG. 2 depicts a system flow diagram for generating asset profiles according to example embodiments of the present disclosure;

FIG. 3A depicts an example interface presenting search criteria options according to example embodiments of the present disclosure;

FIG. 3B depicts another example interface presenting search criteria options according to example embodiments of the present disclosure;

FIG. 4 depicts an example results user-interface according to example embodiments of the present disclosure;

FIG. 5 depicts an example user profile interface according to example embodiments of the present disclosure;

FIG. 6 depicts a data flow diagram for generating depreciation data according to example embodiments of the present disclosure;

FIG. 7 depicts an example relationship between attributes of an example asset profile according to example embodiments of the present disclosure;

FIG. 8 depicts an example method for automatically generating a cost segregation estimate according to example embodiments of the present disclosure; and

FIG. 9 depicts a block diagram of example computing hardware according to example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to improved systems and methods for automatically performing cost segregation analysis on a plurality of assets. In particular, example systems and methods of the present disclosure can automatically generate holistic and accurate cost segregation estimates for a number of assets (e.g., properties, groups of properties (e.g., multiple addresses) associated with the same ownership and/or transaction, etc.) with minimal to no user input. To do so, a computing system can provide a user search interface for searching a plurality of assets across a plurality of States based on search criteria (e.g., purchase price, location, ownership, etc.). The computing system can receive a search query (e.g., via user input to the user search interface) and provide for display (e.g., via a results user interface) a number assets with one or more attributes corresponding to the search query. The computing system can receive a selection of a selected asset (e.g., via the results user interface) and automatically generate a cost segregation estimate for the selected asset. The computing system can provide information corresponding the selected asset and one or more portions of the cost segregation estimate for display to a user of the system.

In this manner, aspects of the present disclosure present an improved user interface for computing devices. Unlike conventional user interface techniques, the computing system employs an improved user-interface that is capable of automatically performing cost segregation analysis with little to no user input. In this manner, the computing system can increase the speed and simplicity of cost segregation analysis by reducing the complexity of user interactions required to perform cost segregation estimates. Moreover, as discussed in detail herein, the resulting cost segregation estimates of the present disclosure improve the accuracy of cost segregation estimates generated using conventional techniques. As a result, the disclosed technology provides the practical application of improving the accuracy of conventional cost segregation estimates while reducing the time and complexity of generating such estimates by enabling the automatic generation of estimates via simplified user interactions.

In this way, aspects of the present disclosure provide an improvement to computing technology. For instance, the user interfaces described herein can facilitate the generation of holistic cost segregation estimates using fewer user interactions with the computing system. This, in turn, allows for preservation of computing resources for one or more other core functions such as, for example, the generation of the holistic cost segregation estimates, etc. Unlike conventional cost segregation estimation techniques, the computing system disclosed herein, generates the holistic cost segregation estimates based on asset features and historical cost segregation data (e.g., not data input by a user). To do so, the computing system maintains an asset database including a previously determined and continuously updated asset profile for each of a number of assets that identify verified, relevant information for a respective asset. The asset profile can include a number of asset attributes for a respective asset. Each attribute can be determined based on historical asset data (e.g., one or more historical purchases, etc.) and verified (e.g., based on a confidence threshold) before being added to a respective asset profile. The asset profile can be continuously updated (e.g., daily, weekly, etc.) with one or more new and/or modified attributes as additional information becomes available.

In addition, the computing system can maintain a historical cost segregation database storing historical segregation data including a plurality of unverified cost segregation estimates (e.g., generated via the systems and methods described herein) and verified cost segregation studies (e.g., cost segregation studies performed) for one or more of the plurality of assets. The computing system can generate a holistic cost segregation estimate for a selected asset by comparing the asset profile to the historical segregation data. In this manner, the computing system can determine highly accurate cost segregation estimates. The asset profile of the disclosed technology allows for more flexible and nuanced cost segregation analysis by enabling the generation of accurate estimates without visualizing the selected asset. Moreover, the cost segregation estimates can be stored (and later used) in the historical database. In this way, the computing system can increase the accuracy of estimates over time based, at least in part, on estimates generated by the system (e.g., using one or more learning techniques, etc.).

The computing system utilizes a specific rules based approach for generating the holistic cost segregation estimate for a selected asset. For instance, computing system can determine at least three different sets of data (e.g., use depreciation data, group depreciation data, optimal depreciation data, etc.) according to one or more specific sets rules. Each set of rules can include a different, specific, comparison between the asset profile of the selected asset with the historical cost segregation data. The computing system can include additional sets of rules to generate additional data such as, for example, benefits analysis, segregation schedules, and the like to generate robust cost segregation estimates. In this manner, the computing system disclosed herein uses a combined order of specific rules the render information (e.g., asset information, historical cost segregation information, etc.) into a specific format (cost segregation estimate, etc.) that can be used and applied to create the desired result of cost segregation analysis.

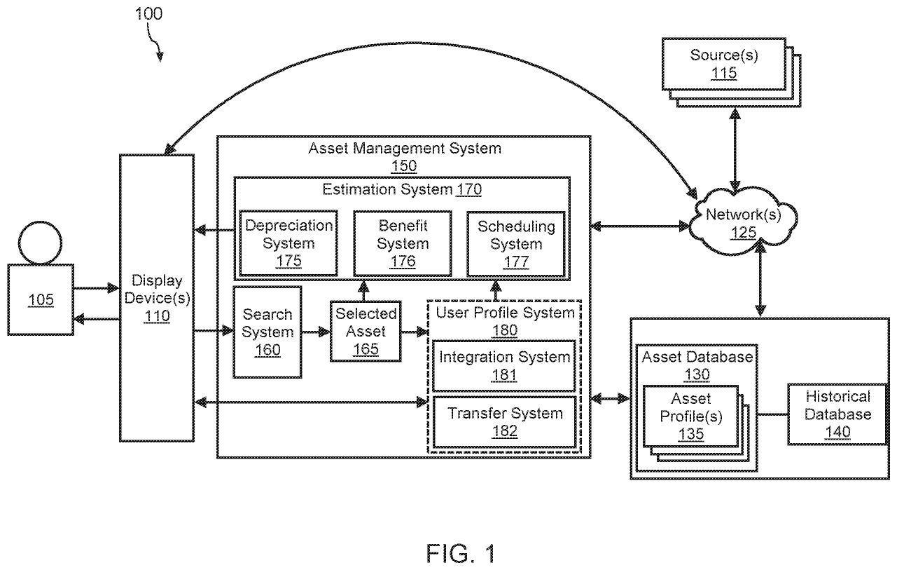

More particularly, FIG. 1 depicts an example computing system 100 according to example embodiments of the present disclosure. Computing system 100 can include an asset management system 150, one or more display device(s) 110, a user 105 that can interact with the asset management system 150 via the one or more display device(s) 110, one or more external data source(s) 115, and an accessible memory 120. In some implementations, the asset management system 150 can include the display device(s) 110 and the accessible memory 120 (e.g., an internal accessible memory). In addition, or alternatively, the asset management system 150 can communicate with the display device(s) 110, the accessible memory 120 (e.g., a remotely accessible memory), and the external data source(s) 115 via a one or more networks 125.

The network(s) 125, for example, can be any type of network or combination of networks that allows for communication between systems and/or devices thereof. In some implementations, the network(s) 125 can include one or more of a local area network, wide area network, the Internet, secure network, cellular network, mesh network, peer-to-peer communication link and/or some combination thereof and can include any number of wired or wireless links. Communication over the network(s) 125 can be accomplished, for instance, via a network interface using any type of protocol, protection scheme, encoding, format, packaging, etc.

The accessible memory 120 can include an asset database 130 storing one or more asset profile(s) 135 and a historical database 140. The asset management system 150 can include one or more subsystem(s) such as, for example, a search system 160, user profile system 180, and/or an estimation system 170. In addition, the one or more subsystem(s) can include one or more additional system(s). For instance, the user profile system 180 can include an integration system 181 and/or a transfer system 182. Moreover, the estimation system 170 can include a depreciation system 175, a benefit system 176, and/or a scheduling system 177.

The asset management system 150 and/or one or more subsystem(s) thereof can include one or more computing device(s) configured to communicate over one or more wired and/or wireless networks. Each computing device can include one or more processors and one or more non-transitory computer-readable media that collectively store instructions that, when executed by the one or more processors, cause the devices to perform operations. In some implementations, each of the subsystem(s) 160, 170, 180 can include one or more subroutines, software processes, services, etc. of the asset management system 150. The asset management system 150 and/or the one or more subsystems can be implemented on one and/or across a plurality of communicatively connected devices (e.g., one or more backend servers, etc.).

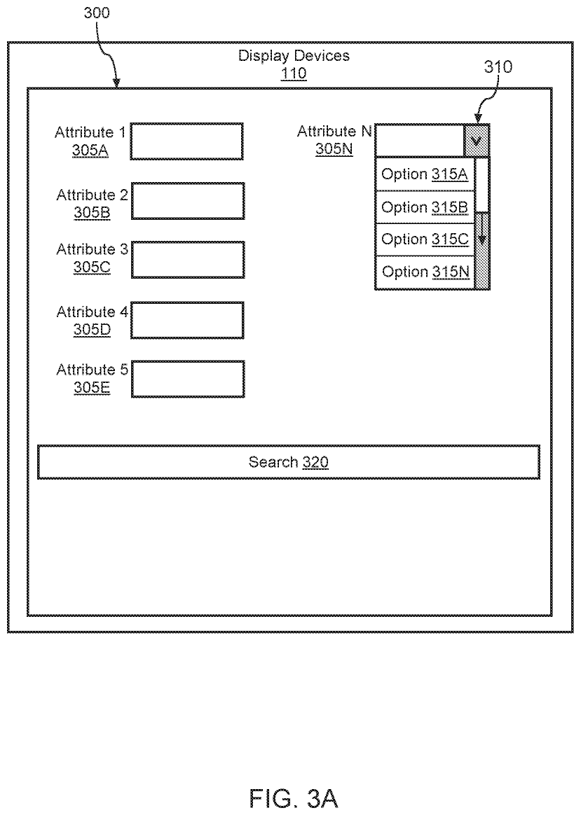

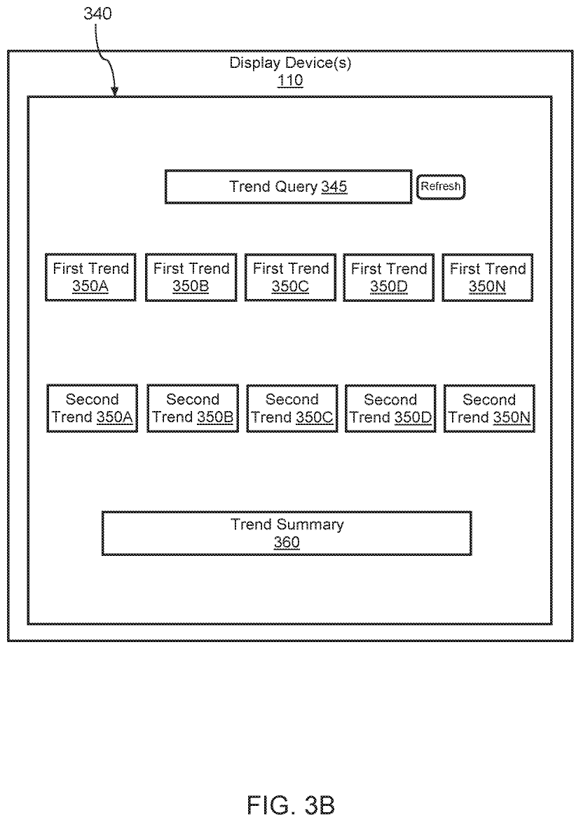

The one or more one or more display device(s) 110 can include one or more local display devices (e.g., monitors, etc.) and/or one or more remote display device(s) (e.g., user devices, etc.). The display device(s) 110 can include visual output device(s) (e.g., visual display units, cathode ray tube screen, solid state screens (e.g., liquid crystal display screens, organic light-emitting diode screen, etc.). The display device(s) 110 can be configured to display one or more interactive user interfaces (e.g., as discussed in further detail herein with reference to FIGS. 3, 4, and 7). As an example, the display device(s) can include one or more user devices (e.g., a smartphone, tablet, laptop, wearable device, display with one or more processors, etc.) with one or more interactive screens (e.g., touch screens, etc.), monitors (e.g., connected to one or more input devices (e.g., hand-held pointing devices (e.g., a computer mouse, etc.), keyboards, etc.), and the like. A user 105 can interact with one or more user interfaces presented by the display device(s) 110 to view data presented by the one or more user interfaces and/or provide user input (e.g., one or more touch inputs via a touch screen, one or more input device inputs, etc.) to the asset management system 150 and/or one or more subsystem(s) 160, 170, 180 thereof.

For example, a user 105 can access an application implemented on a user device. The application can include, for example, a client application with access to one or more functions (e.g., subsystems 160, 170. 180, etc.) of the asset management system 150. The user 105 can interact with one or more specialized graphical user interface(s) of the application to manage one or more assets associated with the accessible memory 120. An asset, for example, can include a property or groups of properties. For instance, an asset can include a group of properties associated with a similar owner or transaction but identified by multiple addresses. For example, and as described in more detail herein, the user 105 can interact with the user interface(s) to select a selected asset 165 from an accessible memory 120 and automatically determine a cost segregation estimate for the selected asset 165. For instance, a cost segregation estimate can be made for a group of properties of the selected asset and, in some implementations, each individual property associated with the group of properties. The selected asset 165, information corresponding to the selected asset 165 such as an asset profile 135, and/or the cost segregation estimate for the select asset 165 can be provided to the display device(s) 110 to be displayed to the user 105.

The asset management system 150 and/or the one or more subsystem(s) 160, 170, 180 can automatically determine the cost segregation estimate and/or other information associated with the selected asset 165 based on data stored by the asset database 130 and/or the historical database 140. For instance, the accessible memory 120 can include one or more databases storing information associated with a plurality of assets. The one or more databases can include the historical database 140 and the asset database 130. The asset database 130 can include an asset profile 135 for each of the plurality of assets. The asset profile 135 can include one or more verified asset attributes associated with a respective asset. The asset profiles 135 can be previously generated for each of the plurality of assets. In some implementations, the asset profiles 135 can be continuously updated as new data becomes available.

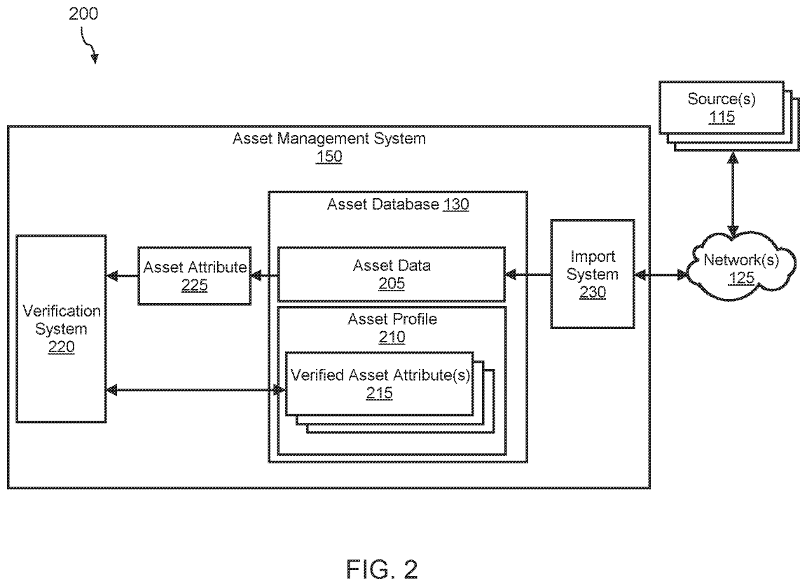

By way of example, FIG. 2 depicts a system flow diagram 200 for generating asset profiles according to example embodiments of the present disclosure. The asset database 130 can include asset data 205 and plurality of asset profiles such as example asset profile 210. The asset profile 210 can include verified asset attributes 215. The asset management system 150 (e.g., import system 230) can be configured to import asset data 205, via the one or more networks 125, from one or more external sources 115. The one or more external sources 115 can include a plurality of disparate databases stored on one or more remote computing devices (e.g., one or more remote servers, etc.). Each of the one or more external sources 115 can include property and/or transaction related information for one or more of the plurality of assets. For instance, the external sources 115 can include resources offered by county reporter offices, tax reporter offices, and/or any other resource that provides property and/or transaction information.

The import system 230 can be configured to access, via the one or more networks 125, the one or more external sources 115 to obtain the asset data 205 and import the asset data 205 to the asset database 130. In some implementations, the import system 230 can be configured to automatically import additional asset data on an importation schedule. The importation schedule can define a frequency with which the import system 230 can import addition asset data to the asset database 130. The importation schedule can include any recurring time period such as, for example, an hourly, daily, weekly, monthly, etc. time period. By way of example, the importation schedule can define a daily frequency. In this manner, the import system 230 can work unattended on a daily basis to import additional asset data from the one or more external sources 115 to the asset database 130.

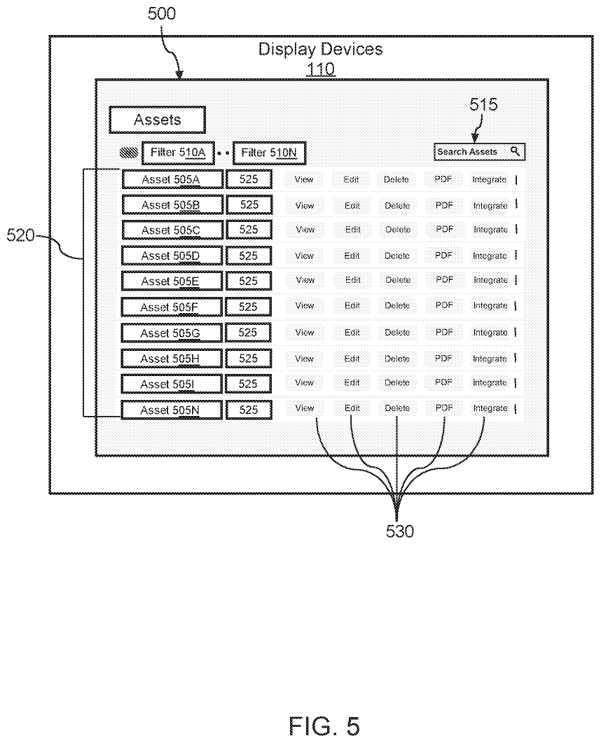

As discussed in greater detail herein, in some implementations, the import system 230 can be configured to analyze the additional asset data to determine one or more purchasing trends. For instance, the import system 230 can determine which State (e.g., of the United States) have had the most purchases in the past 30 days (e.g., based on owner addresses), which owners have made the most purchases, the newest transactions that occurred in a previous day, week, month, etc., mortgage rates, and/or any other purchasing trend. By way of example, the purchasing trends can include the top five States with the most transactions over a specific time period, the top property group with the most transactions within each of the top five States over the specific time period, and/or a summary of the total property transactions and/or top five property groups within the total property transaction. Such purchasing trends can be determined with the same frequency in which the import system 230 can import additional asset data and can be stored in the asset database 130. In some implementations, the purchasing trends can be displayed to one or more users of the asset management system 150 (e.g., via one or more homepage(s) of FIG. 3B, one or more user profile(s) of FIG. 5, etc.). In this manner, users can target assets which are the most popular (e.g., based on which State had the most recent purchases), recognize increased purchasing activity, identify purchasing trends and mortgage rates to determine how much money is left on mortgages, which rates are being paid, etc.

The asset data 205 can include a plurality of asset attributes for each of the plurality of assets. An asset attribute can include historical, transactional, and/or tax related information corresponding to an asset. By way of example, an asset attribute can be indicative of at least one of location data, ownership data, price data, a group classification, a use classification, a footprint, depreciation data, and the like. An asset attribute indicative of location data, for example, can include an address attribute identifying the physical address of the asset. An asset attribute indicative of ownership data can identify one or more characteristics of current and/or previous owners of the asset such as, for example, the owner type (e.g., individual, business, non-profit, etc.), the owner's residency, name, contact information (e.g., mailing address, email address, phone number, etc.), and the like. An asset attribute indicative of price data can identify one or more purchase prices (e.g., corresponding to one or more sales over time) for the asset, a type of purchase, mortgage information, and the like. An asset attribute indicative of a use classification can identify a property use code such as, for example, a municipality code assigned to the asset by a respective municipality and/or any other classification associated with the use of an asset. An asset attribute indicative of a group classification can identify a group classification assigned to the asset, as described in greater detail herein. An asset attribute indicative of a footprint can identify a lot size and/or a building size of the asset (e.g., in square feet, yards, acres, etc.).

The asset data 205 can include a plurality of attribute values for each attribute of an asset. For example, the asset data 205 can include an asset attribute value for a respective attribute as recorded during one or more transfers of ownership of the asset, during one or more tax events involving the asset, during one or more cost segregation evaluations, etc. In some cases, the asset attribute values can be irrelevant (e.g., no longer current, etc.), redundant (e.g., repeating values, etc.), incorrect, and/or misleading. To improve the speed and efficiency of generating a cost segmentation estimate and increase the accuracy thereof, the asset management system 150 (e.g., the verification system 220) can generate an asset profile for each asset of the asset database 130 based on the asset data 205. The asset profile 210, for example, can include a plurality of verified asset attributes 215 (e.g., one verified asset attribute per asset attribute) corresponding to an asset (e.g., the selected asset 165 of FIG. 1). As described herein, the asset management system 150 (e.g., verification system 220, import system 230, etc.) can be configured to discriminate duplicates and/or invalid data to generate the asset profile 210.

More particularly, the asset management system 150 (e.g., the verification system 220) can obtain an asset attribute 225 from the asset data 205. The verification system 220 can compare one or more values of the asset attribute 225 to verify the asset attribute 225. For example, the verification system 220 can determine a confidence score for the asset attribute 225 based on one or more asset attribute values corresponding to the asset attribute 205. By way of example, the verification system 220 can determine a higher confidence score for an asset attribute with a number of redundant (e.g., repeating) values, a value reported by a trusted external source, and/or any other indicia of trustworthiness. In addition, or alternatively, the verification system 220 can determine a lower confidence score for an asset attribute with a number of contradicting values, and/or any other indicia of untrustworthiness. In like manner, the verification system 220 can determine a confidence score for each different value corresponding to the asset attribute 225 (e.g., a higher confidence score for more current values, duplicate values, etc.). The verification system 220 can assign an attribute confidence score and the value associated with the highest value confidence score to the asset attribute 225. In this manner, the verification system 220 can assign a confidence score and value to each of the plurality of asset attributes corresponding to an asset (e.g., a selected asset 165 of FIG. 1).

The verification system 220 can add the asset attribute 225 (e.g., with the value associated with the highest confidence score) to the asset profile 210 if the asset attribute 225 is assigned an attribute confidence score higher than a confidence score threshold. The confidence score threshold can be a predetermined value (e.g., 50%, 70%, etc.) for each asset attribute and/or dynamically determined based on the asset attribute (e.g., a higher threshold for asset attributes indicative of location data, a lower threshold for asset attributes indicative of use classifications, etc.). The asset management system 150 can generate the asset profile 210 based, at least in part, on the confidence score for each of a plurality of asset attributes corresponding to an asset.

By way of example, an asset attribute assigned a confidence score under the confidence score threshold can trigger a manual review. During the manual review, a manually verified value can be assigned to the asset attribute. In this manner, the asset profile 210 for an asset can include one or more verified asset attributes 215 associated with a respective confidence score above a confidence threshold. Moreover, manually verified values can subsequently be used to automatically determine one or more attribute values and/or confidence scores for other asset attributes such that the verification system learns to accurately verify one or more attributes over time.

In some implementations, the asset management system 150 can determine a confidence score for a use classification attribute associated with an asset. The system 150 can verify the use classification based on the confidence score. In the event that the confidence score is below a confidence threshold, the system 150 can determine one or more alternative use classifications for the asset based on one or more asset attributes of the asset. By way of example, the system 150 can include one or more models, functions, etc. trained, coded, etc. to determine one or more use classifications for an asset based on the one or more asset attributes of the asset. In this manner, an asset profile 210 can include a plurality of use classifications (e.g., a use classification and one or more alternative use classifications).

In this way, the asset database 130 can include a plurality of previously generated and continuously maintained asset profiles (e.g., asset profile 215). The asset management system 150 can compile asset data 130 overtime into one record (e.g., asset profile 210) such that all available, current, and accurate asset information is readily accessible. In so doing, the asset profile 210 can provide a comprehensive overview of all available, current, and accurate attributes that have been reported to one or more external sources 115 over a number years and/or determined for the asset by the system 150 based on one or more other assets attributes.

Turning back to FIG. 1, the accessible memory 120 can include a historical database 140. The historical database 140 can include historical cost segregation data indicative of a plurality of previous cost segregation studies for one or more of the plurality of assets. By way of example, the historical database 140 can include a plurality of real results from previous cost segregation studies. More particularly, the historical database 140 can track previously determined allocations to five and fifteen year property for an asset (e.g., depreciation data). In addition, the historical database can include corresponding asset data associated with the previously determined allocations such as, for example, the square footage of the lot and building, property group, type, and municipality, etc. of the asset for which the previous cost segregation study was performed. As discussed in detail herein, a cost segregation estimate for the selected asset 165 can be automatically generated based, at least in part, on the historical cost segregation data. In some implementations, the cost segregation estimated can be stored in the historical database 140. In this manner, additional cost segregation estimates can be automatically generated based, at least in part, on previous cost segregation estimates such that the accuracy and scope of newly generated cost segregation estimates can increase over time.

As an example, the asset management system 150 can automatically generate a new cost segregation estimate for the selected asset 165 based, at least in part, on user input. For example, the asset management system 150 can obtain user input indicative of the selected asset 165 from user 105. To do so, the asset management system 150 can provide for display to the user 105, via the one or more display devices 110, a user search interface presenting one or more search criteria options. By way of example, FIGS. 3A and 3B depict example user interfaces 300 and 340 presenting search criteria options according to example embodiments of the present disclosure. With reference to FIG. 3A, the user search interface 300 can be provided to the user via one or more display device(s) 110. The interface 300 can include a plurality of interactive widgets 305A-N (e.g., interactive buttons, drop down box, text input box, etc.) with which a user can interact to create a search query.

The widgets 305A-N can include a separate widget for each of one or more attributes of an asset. For example, interface 300 can include a widget for each attribute corresponding to at least one asset profile of the asset database. By way of example, a widget 305A can include an interactive component configured to accept footprint criteria (e.g., a maximum/minimum lot size, maximum/minimum building size, and/or a range thereof), transaction criteria (e.g., a specific transaction date (e.g., last purchase date, sale date, etc.), transactions within a range of time (e.g., assets that have been purchased, sold, etc. within the last year, two years, between two and three years ago, etc.), etc.), price criteria (e.g., minimum/maximum last sales price, etc.), age criteria (e.g., minimum/maximum year built), location criteria (e.g., specific address, minimum/maximum distance from user, one or more different states, counties, municipalities, cities, zip codes, etc.), owner criteria (e.g., residency (e.g., as determined from the owner's mailing address), name, type (e.g., individual, business, non-profit, etc.), etc. of the owner of the asset), asset group classification criteria (e.g., assets that fall within one or more group classifications, assets that do not fall into one or more group classifications, etc.), use classification (e.g., assets that fall within one or more use classifications, assets that do not fall into one or more use classifications, etc.), and/or any other criteria associated with one or more assets of the asset database.

As one example, a widget (e.g., widget 305N) can include an interactive component with a drop down option 310 presenting one or more search options 315A-N for an attribute. By way of example, a widget (e.g., widget 305N) configured to accept group classification criteria can present a plurality of group classification options for selection by the user, etc. The user can select one or more of the plurality of search options 315A-N to identify search criteria for an asset query. In addition, or alternatively, the user can interact with any number of different types of interactive widgets (e.g., interactive components such as text boxes, etc.) to select different search criteria for an asset query.

In this manner, the asset management system 150 can obtain search criteria indicative of one or more asset attributes. For instance, the asset management system 150 can obtain, via the user search interface 300, query user input indicative of the search criteria for one or more of the plurality of assets of the asset database. As an example, the search criteria can include at least one of location data, ownership data (e.g., the mailing address of the owner, etc.), price data, a group classification, a use classification, footprint data (e.g., building size, lot size, etc.), depreciation data, and/or any other data associated with an asset of asset database. By way of example, the query user input can include a selection of one or more different search criteria presented by the user search interface 300. The user can provide the query user input to establish the search criteria for an asset query and select a search option 320 presented by the user search interface 320 to initiate the asset query. In this manner, the asset management system 150 allows a user to easily query assets based on different parameters such that the user can target certain areas, assets, purchases, owners, and/or the like.

With reference to FIG. 3B, a home interface 340 can be provided to the user via the one or more display device(s) 110. The interface 340 can include a plurality of interactive widgets (e.g., interactive buttons, drop down box, text input box, etc.) with which a user can interact to create a trend query 345. The trend query 345, for example, can include a specific time frame (e.g., within one or more days, months, years, etc., within the month, year, etc., a range between two specific dates, etc.) with which to determine one or more purchasing trends. The user can interact with the interactive widgets to select a trend query 345 to initiate. In this way, the home interface 340 can act as a real time real estate analytic tool that allows the user to pinpoint trending areas and property types being purchased with a dynamically set time frame.

In response to the user input, the asset management system 150 can provide for display, via the home interface 340, one or more purchasing trends with the set time frame. By way of example, the purchasing trends can include one or more first trends 350A-N (e.g., the top five States with the most transactions during the set time frame, etc.), one or more second trends 355A-N (e.g., the top property group with the most transactions in each of the five States, etc.), and/or a trend summary 360 (e.g., the overall purchases during the set time frame and/or the top overall property groups within the set time period, etc.). In some implementations, the home interface 340 can include an interactive map. In such a case, the one or more purchasing trends can be provided for display in relation to one or more geographic locations (e.g., States, countries, etc.) associated with one or more of the purchasing trend(s) via the interactive map interface.

In some implementations, the user can interact with the one or more purchasing trends 350A-N, 355A-N to provide search criteria for an asset query. For instance, the user can select (e.g., via user touch input, input device input, etc.) a purchasing trend (e.g., 350A) to identify search criteria associated with the purchasing trend (e.g., 350A). By way of example, the first purchasing trend 350A can identify the State with the most transactions during a set time frame. In such a case, home query input directed to the presented first purchasing trend 350A can identify search criteria including the set time frame and the State. In this manner, the home interface can enable a user to query specific assets (e.g., to view asset profiles and/or other details, generate a cost segregation estimate, etc.) based on one or more recent trends associated with the plurality of assets of the asset database. This, in turn, can enable more informed queries to a plurality of assets.

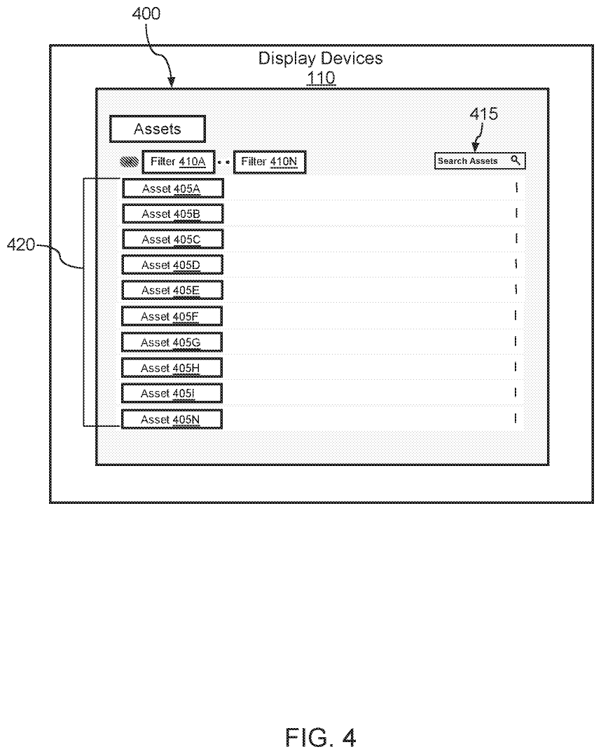

FIG. 4 depicts an example results user interface 400 according to example embodiments of the present disclosure. The asset management system 150 (e.g., search system 160) can identify one or more of the plurality of assets based, at least in part, on the search criteria (e.g., identified by the query user input, home query input, etc.). The asset management system 150 (e.g., search system 160) can generate a subset of assets 405A-N to be displayed to the user based on the assets identified. Each of the assets of the subset of assets 405A-N, for example, can satisfy one or more of the search criteria. By way of example, each of the assets 405A-N can be associated with an asset profile with one or more asset attributes achieving the search criteria (e.g., an age attribute with an age range, an owner attribute identifying a selected state residency, attributes corresponding to a selected trend, etc.). In this manner, the asset management system 150 (e.g., search system 160) enables a user to query asset information and related transactions from the asset database and/or, in some implementations, directly from an external source.

The asset management system 150 (e.g., search system 160, etc.) can provide for display to the user, via the one or more display devices 110, a results user interface 400 presenting one or more of the plurality of assets for selection by the user. The one or more assets, for example, can include the subset of assets 405A-N identified in response to the search criteria. By way of example, the results user interface 400 can present a selectable list 420 of the subset of assets 405A-N. Thus, the asset management system 150 (e.g., search system 160, etc.) can provide for display, via one or more display devices 110, a user interface 400 presenting a visual representation of the assets 405A-N for selection by a user. As described herein, each of the assets 405A-N can be associated with the one or more asset features.

In some implementations, the results user interface 400 can include one or more additional interactive components. By way of example, the results user interface 400 can include one or more order widgets 410A-N and/or a sub search options 415. Each of the one or more order widgets 410A-N can organize the assets 405A-N based on one or more criteria such as, for example, each asset's address, owner, owner type, property group, municipality code, sale date, sale amount, and/or any other asset attribute corresponding to the assets 405A-N. The sub search option 415 can add additional criteria to the search criteria of the asset query. In this manner, the results user interface 400 can enable a user to search for one or more assets within the subset of assets 405A-N. The user can interact with the selectable list 420 of the assets 405A-N to select an asset. In this manner, the asset management system 150 can receive a selected asset.

Turning back to FIG. 1, the asset management system 150 can obtain (e.g., via the results user interface 400 of FIG. 4) a selection user input indicative of the selected asset 165. The selection user input can be an input identifying (e.g., selecting) an asset from the assets (e.g., assets 405A-N) presented by the user interface (e.g., results user interface 400). The selected asset 165, for example, can include at least one asset of the subset of displayed assets (e.g., assets 405A-N). In some implementations, the asset management system 150 (estimation system 170) can automatically generate a cost segregation estimate (e.g., in the manner described herein) for the selected asset 165 in response to the selection user input. In addition, or alternatively, the asset management system 150 (estimation system user profile system 180) can, in response to the user input, provide for display to the user 105, via the one or more display devices 110, a user profile option interface presenting one or more user profile options for selection by the user 105.

The user profile options, for example, can include a personal user profile and/or a commercial user profile option. The user 105 can interact with the user profile option interface to add the selected asset 165 to a personal file for personal review (e.g., by interacting with the personal profile option, etc.) and/or a sales file (e.g., by interacting with the commercial profile option, etc.) for adding contact information, notes, and contact events. Each profile can be associated with one or more previously selected assets. In addition, each profile can include one or more interactive widgets to view an asset profile of a selected asset, edit the asset profile of the selected asset, delete the selected asset from the assets associated with the profile, convert, via the integration system 181, information associated with the selected asset to a letter for transmittal to one or more clients (e.g., an owner of an asset, etc.), and/or transfer, via the transfer system 182, the information associated with the selected asset to one or more remote applications (e.g., other applications such as excel, Salesforce, etc.).

For example, if a user wants to target certain types of assets in certain areas, the user can query those assets and create a commercial profile for them. Once the commercial profile is complete, the user can download one or more client letters, via the integration system 181, with cost segregation estimate information attached thereto. In some implementations, the integration system 181 can be configured to automatically mail and/or email the one or more client letters to the one or more clients.

The asset management system 150 (e.g., user profile system 180) can obtain, via the user profile option user interface, user profile input indicative of a user profile option. The user profile option can be indicative of the user's intention to supplement a personal user profile and/or one or more commercial user profile(s) (e.g., a commercial profile for each group of assets, etc.) with the selected asset 165. By way of example, the user 105 can be associated with the personal user profile and/or the one or more commercial user profile(s). The personal user profile can include a personal subset of assets for the user's personal review. Each of the commercial user profile(s) can include a subset of assets grouped by one or more criteria (e.g., one or more attributes such as State, asset type, etc.) and supplemented with contextual information such contact information, notes, contact events, etc.

The asset management system 150 (e.g., user profile system 180) can enable the user 105 to group assets into personal or one or more commercial profile(s) for additional asset management such as updating contact information, managing contact events, and/or adding notes to specific asset. When a selected asset 165 is added to a profile (e.g., a personal profile, commercial profile, etc.), the asset management system 150 (e.g., estimation system 170) can automatically generate a cost segregation estimate for the selected asset 165. In addition, or alternatively, the asset management system 150 (e.g., estimation system 170) can generate a client profile for the asset in which the user 105 can add notes, add contact events such as phone calls, emails, etc., update contact information, generate a new cost segmentation estimates based on additional asset information, etc.

By way of example, FIG. 5 depicts an example user profile interface 500 according to example embodiments of the present disclosure. The user interface 500 presents a selectable list 520 of one or more user assets 505A-N (e.g., each of a plurality of previously selected assets). In addition, the user interface 500 can present asset information 525 for each of the one or more user assets 505A-N. The asset information 525 can include at least one of a respective asset profile and/or a respective holistic cost segregation estimate for an asset (e.g., selected asset 165). In some implementations, the user profile interface 500 can include one or more additional interactive components. By way of example, the user profile interface 500 can include one or more order widgets 510A-N and/or a sub search option 515. Each of the one or more order widgets 510A-N can organize the assets 505A-N based on one or more criteria such as, for example, each asset's address, owner, owner type, property group, municipality code, sale date, sale amount, and/or any other asset attribute corresponding to the assets 505A-N. The sub search option 515 can enable the user to input search criteria for filtering the one or more user assets 505A-N. In this manner, the user profile interface 500 can enable a user to search for one or more assets within the one or more user assets 505A-N.

In addition, in some implementations, the user profile interface 500 can include one or more interactive widgets 530. Each of the interactive widgets 530 can enable the user to interact with a specific asset (e.g., asset 505A). As an example, the interactive widgets 530 can include a viewing widget (e.g., an interactive button, etc.). The user can provide user input to the viewing widget to instruct the asset management system 150 to present an asset profile for a respective asset. As another example, the interactive widgets 530 can include an editing widget (e.g., an interactive button, etc.). The user can provide user input to the editing widget to instruct the asset management system 150 to present an editable asset profile for a respective asset. The user can interact with the editable asset profile to add, modify, and delete one or more attributes of the asset profile. The interactive widgets 530 can include a deletion widget (e.g., an interactive button, etc.). The user can provide user input to the deletion widget to instruct the asset management system 150 to remove the respective asset from the one or more user assets 505A-N. Moreover, in some implementations, the interactive widgets 530 can include an integration and/or transfer widget (e.g., an interactive button, etc.). The user can provide user input to the integration and/or transfer widget to instruct the asset management system 150 to generate a client letter by integrating asset information (e.g., from the asset profile, holistic cost segregation, etc.) to a customer letter or generate a transferable file (e.g., an excel file, etc.) representative of the asset information such that the asset information can be imported to one or more other applications (e.g., Salesforce, etc.).

The interactive widgets 530 discussed herein are provided as examples only, the user profile interface 500 can include any number of different interactive widgets 530 than those described herein. By way of example, the interactive widgets 530 could include a mapping widget configured to present an interactive map centered around the respective asset, and/or any other interactive widget that may enable a user to interact with a respective asset. In some implementations, the user can be associated with one or more user permissions. In such a case, each of the interaction widgets can be available to the user based at least in part on the user's user permissions. As an example, a user with admin permissions can be able to delete an asset from a commercial user profile, whereas a user without admin permissions can be restricted to adding an asset to a commercial user profile.

Turning back to FIG. 1, the asset management system 150 (e.g., estimation system 170) can automatically generate a holistic cost segregation estimate for the selected asset 165 in response to one or more user inputs (e.g., a selection user input, the user profile input (e.g., if the user profile input is indicative of the personal user profile, the commercial user profile, etc.), etc.). The holistic cost segregation estimate can include depreciation data, benefit data, and/or segregation schedule data. In some implementations, the estimation system 170 can implement one or more subsystems (e.g., devices, processes, subroutines, etc.) configured to generate one or more components of the cost segregation estimate. For example, the estimation system 170 can include a depreciation system 175 configured to generate depreciation data (e.g., a holistic depreciation estimate), a benefit system 176 configured to generate benefit data (e.g., catch up depreciation), and/or a scheduling system 177 configured to generate segregation schedule data (e.g., one or more cost segregation schedule(s), etc.).

The holistic cost segregation estimate can be generated based, at least in part, on historical cost segregation data of the historical database 130 and/or a respective asset profile (e.g., of the asset profile(s) 135) corresponding to selected asset 165. For example, the asset management system 150 (e.g., estimation system 170, etc.) can obtain and/or generate an asset profile for the selected asset 165. The asset profile 135 can be predetermined in the manner described herein. For example, in some implementations, the asset database 130 can include an asset profile for each asset of the asset database 130. For instance, each asset profile 135 can be predetermined for an asset at the time and/or before the asset is added to the asset database 130. In such a case, the asset profile 135 (and/or one or more asset attributes thereof) can be continuously updated when new data is available (e.g., from one or more external sources 115).

In addition, or alternatively, in some implementations, the asset profile 135 can be determined in real time. For instance, the asset management system 150 can access the asset database 130 and/or the historical database 140 to obtain one or more asset attributes corresponding to the selected asset 165 and/or historical cost segregation data corresponding to the selected asset 165. The asset management system 150 can generate the asset profile for the selected asset 165 based on the one or more asset attributes and/or the historical cost segregation data. By way of example, the asset profile can include one or more verified asset attributes corresponding to the selected asset 165 and/or one or more historical cost segregation studies (e.g., cost segregation estimates, one or more components (e.g., depreciation data, benefit data, segregation schedule data, etc.) thereof, and/or one or more real cost segregation studies performed for the selected asset 165).

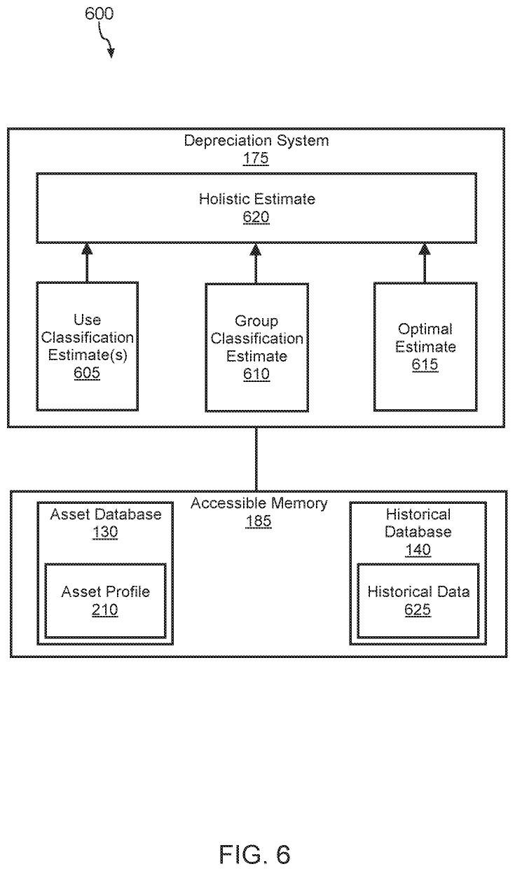

The asset management system 150 (e.g., estimation system 170) can automatically generate the holistic cost segregation estimate and/or a portion thereof based on the asset profile(s) 135. FIG. 6, for example, depicts a data flow diagram 600 for generating depreciation data according to example embodiments of the present disclosure. The depreciation system 175 can determine holistic depreciation data indicative of a holistic depreciation estimate 610 based on the asset profile 210 corresponding to the selected asset and historical cost segregation data 625 of the historical database 140. The holistic depreciation data (e.g., estimate 620), for example, can include a five year depreciation average and/or a fifteen year depreciation average for the selected asset. The depreciation system 175 can generate the holistic depreciation data (e.g., estimate 620) based on at least one of the use depreciation data (e.g., estimate 605), group depreciation data (e.g., estimate 610), and/or optimal depreciation data (e.g., estimate 615).

By way of example, the depreciation system 175 can obtain one or more asset attributes from the asset profile 210 such as, for example, an asset identifier, a use classification, an address state, a last sale date, a last sale price, a building size and/or a lot size. In addition, the depreciation system 175 can obtain (via the asset profile 210 and/or one or more other sets of data based on the asset identifier) a tax market value total and/or a tax assessed value total.

In some implementations, the one or more asset attributes of the asset profile 210 can include one or more use classification(s) (e.g., a use classification and/or one or more alternative use classifications). In such a case, the depreciation system 175 can determine use depreciation data (e.g., use classification estimate(s) 605) for the selected asset based, at least in part, on the use classification(s) and the historical cost segregation data 625. For example, the depreciation system 175 can identify one or more historical cost segregation studies and/or estimates from historical cost segregation data 625 that correspond to one or more assets associated with a respective use classification of the use classification(s) of the selected asset. For instance, the one or more historical cost segregation studies and/or estimates can be previously performed and/or generated for one or more respective assets of the asset database 130 that include a use classification matching a respective use classification of the selected asset. The depreciation system 175 can aggregate the one or more historical cost segregation studies and/or estimates to determine a use classification estimate for the respective use classification. This process can be repeated for each use classification of the use classification(s) corresponding to the selected asset. The resulting use classification estimate(s) 605 can include a use classification five year estimate indicative of the average five year depreciation percentage for the one or more respective assets and/or a use classification fifteen year estimate indicative of an average fifteen year depreciation percentage for the one or more respective assets. The holistic cost segregation estimate 620 can be generated based, at least in part, on the use depreciation data (e.g., estimate 605). For instance, a use classification estimate of the use classification estimate(s) 605 can be selected for use based on one or more factors. The selected use classification estimate can be used to generate the holistic cost segregation estimate 620. In addition, or alternatively, a holistic cost segregation estimate 620 can be generated for each different use classification estimate generated for the selected asset.

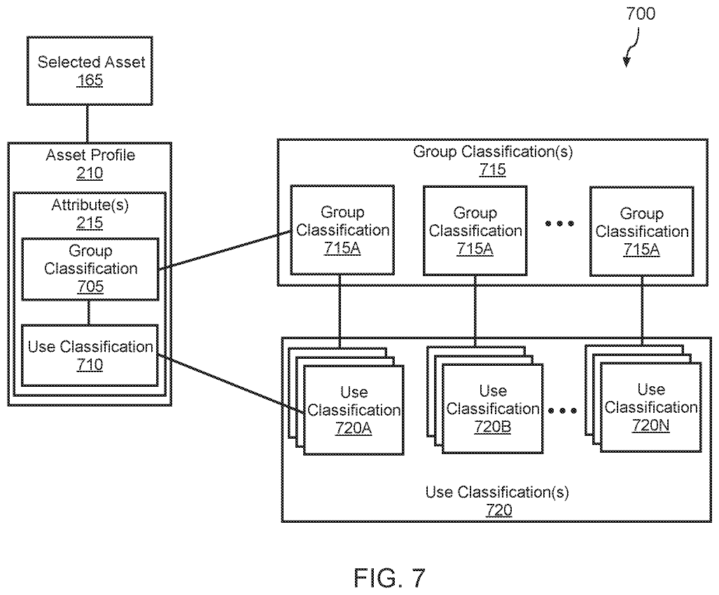

The asset profile 210 can include an asset group classification. In addition, or alternatively, the group classification can be determined based, at least in part, on the use classification estimate(s) 605. By way of example, FIG. 7 depicts an example relationship 700 between attributes of an example asset profile according to example embodiments of the present disclosure. As depicted, the selected asset 165 can be associated with an asset profile 210 with one or more attribute(s) 215. The attribute(s) 215 can include a use classification 710 and/or an asset group classification 705. The asset group classification 705 can identify a respective asset group (e.g., 715A) of a plurality of predefined asset groups 715.

More particularly, the asset group classification 705 can include one of a plurality of group classifications 715. The plurality of group classifications 715 can include a plurality of predefined group classifications 715A-N. Each respective group classification (e.g., group classification 715A) of the plurality of predefined asset groups 715A-N can be indicative of an association between one or more use classifications 720 (e.g., use classifications 720A). The group classifications 715 can separate a larger number of use classifications 720 into larger pools of similarity. For instance, group classification(s) 715 can be created to group over three-hundred and sixty-six standardized asset use classifications 720 into groups 720A-N that reflect the type and amount of five and fifteen year property an asset typically has. By way of example, each group classification of the group classification(s) 715 can link a plurality of use classifications 720 (e.g., municipality codes and/or other standardized codes or categories for a property) based on similar historical cost segregation information such as, for example, similar depreciate data associated with assets classified by the plurality of use classifications.

By way of example, a property group classification (e.g., 715A) can include retail, industrial, restaurant, warehouse, residential, miscellaneous, office, gas station, commercial condominium, mix use, medical, parking garage, hotel, car wash, manufacturing, recreation, car dealership, golf course, residential condominium, commercial miscellaneous, multi-family, etc. classifications. Each group classification (e.g., 715A) can identify a similarity between a plurality of use classifications (e.g., 720A). As one example, a group classification of retail can include one or more different use classifications such as shopping malls, clothing outlets, etc. In addition, a group classification of car wash can include one or more different State specific use classifications used to identify car washes across one or more different States. In some implementations, the computing systems described herein can validate a use classification assigned to an asset by an external source (e.g., a municipality code assigned by county reporter, etc.) based on the group classification and/or one or more historical cost segregation studies.

The asset management system 150 can obtain a previously determined asset group classification 705 from the asset profile 210. For example, generating the asset profile 210 can include determining the asset group classification 705 for the selected asset 165 based, at least in part, on the one or more asset attributes 215 (e.g., use classification 710) corresponding to the selected asset 165. In addition, or alternatively, the asset management system 150 can determine asset group classification 705 in real time after the selection of the selected asset 165. For example, the asset management system 150 can access a relationship table identifying one or more relationships between one or more predefined group classification(s) 715A-N and one or more sets of use classifications 720A-N. The asset management system 150 can compare the use classification 710 of the selected asset 165 to the relationship table to determine the group asset classification 705. In the event, the relationship table does not specify a relationship between the use classification 710 and at least one group asset classification 715A-N, the asset management system 150 can assign a default value (e.g., commercial miscellaneous) to the group asset classification 705.

Turning back to FIG. 6, the depreciation system 175 can determine group depreciation data (e.g., estimate 610) for the selected asset based, at least in part, on the asset group classification corresponding, assigned, etc. to the selected asset and the historical cost segregation data 625. For example, the depreciation system 175 can identify one or more historical cost segregation studies and/or estimates from historical cost segregation data 625 that correspond to one or more assets associated with the group classification. For instance, the one or more historical cost segregation studies and/or estimates can be previously performed and/or generated for one or more respective assets of the asset database 130 that include a group asset classification matching the group asset classification of the selected asset. The depreciation system 175 can aggregate the one or more historical cost segregation studies and/or estimates to determine a group classification estimate 610.

The group classification estimate 610 can include a group classification five year estimate indicative of the average five year depreciation percentage for the one or more respective assets and/or a group classification fifteen year estimate indicative of an average fifteen year depreciation percentage for the one or more respective assets. The depreciation system 175 can generate the holistic cost segregation estimate 620 based, at least in part, on the group depreciation data (e.g., estimate 610).

The depreciation system 175 can obtain a number of additional attributes from the asset profile 210. In some implementations, the depreciation system 175 can generate one or more temporary attributes and assign a value to the temporary attribute(s) based on the number of additional attributes from the asset profile 210.

For instance, the depreciation system 175 can obtain last sale date for the asset indicative of the date on which the asset was last sold. If the asset profile 210 includes a last sale data attribute, the depreciation system 175 can set a temporary place in service date attribute to the value of the last sale date attribute. Alternatively, the depreciation system 175 can set the temporary place in service date attribute to the most recent instrument date associated with the selected asset from the asset data. As another example, the depreciation system 175 can obtain a purchase price from the asset profile. For instance, the depreciation system 175 can assign a value to a temporary purchase price attribute for the selected asset based on the higher value between a last sale amount attribute indicative of the sale price for the asset at the last sale, a tax market value total attribute indicative of tax value of the asset, and/or a tax assessed value total attribute indicative of the assessed tax value of the selected asset.

The depreciation system 175 can obtain system configuration parameters. The system configuration parameters can include a federal tax rate, a mid-quarter convention, a leasehold value indicating whether the selected asset is a lease hold, and/or a net present discount factor. In addition, the system configuration parameters can include a state tax rate (e.g., obtained based on a location attribute of the asset profile 210), a bonus depreciation value (e.g., obtained based on the place in service date), and/or a residential flag value indicating whether the asset group classification is residential.

The depreciation system 175 can utilize one or more of the asset attributes from the asset profile 210 and/or the one or more temporary asset attributes to determine optimal depreciation data (e.g., estimate 615). As an example, the one or more asset attributes (e.g., temporary attribute, from the asset profile 210, etc.) can include a purchase price and an asset footprint indicative of at least one of a building size and/or a lot size. The depreciation system 175 can determine an optimal asset for the selected asset based, at least in part, on the asset profile 210 and/or the one or more asset attributes. The optimal asset can include the most similar asset from a subset of assets of the asset database 130 that is associated with a cost segregation study and/or estimate of the historical cost segregation data 625. The subset of assets, for example, can include a use subset of assets including each of the assets of the asset database 130 associated with a use classification matching the use classification of the selected asset. In addition, or alternatively, for example, in the event the use subset of assets does not include any asset associated with a cost segregation study and/or estimate from the historical database, the subset of assets can include a group subset of asset including each of the assets of the asset database 130 associated with an asset group classification matching the asset group classification of the selected asset.

The depreciation system 175 can determine a similarity value for each of the subsets of assets (e.g., the use subset, the group subset, etc.) of the asset database 130 based, at least in part, on a comparison between the purchase price and/or the asset footprint (e.g., building size and/or lot size) corresponding to the selected asset and a respective purchase price or asset footprint (e.g., building size and/or lot size) corresponding to each respective asset of subset of assets. The depreciation system 175 can determine the optimal asset from the subset of assets based, at least in part, on a similarity value for each of the subset of assets.

More particularly, the depreciation system 175 can search the asset database 130 and/or the historical database 140 for at least two assets with similar purchase prices to the selected asset. For instance, the at least two assets can include one asset (and/or study (e.g., real and/or estimated cost segregation analysis) associated with the asset) with the closest lower purchase price to the purchase price of the selected asset and another asset (and/or study (e.g., real and/or estimated cost segregation analysis) associated with the asset) with the closest higher purchase price to the purchase price of the selected asset. The optimal asset can be determined from the at least two assets. For instance, the optimal asset can include the asset associated with the closest building size to the building size of the selected asset. In addition, or alternatively, the optimal asset can include the asset with the closest lot size to the lot size of the selected asset. In some implementations, for example, in the event the asset profile 210 does not include a building size attribute or a lot size attribute, the optimal asset can include the asset with the closest purchase price to the purchase price of the selected asset.

The depreciation system 175 can determine optimal depreciation data (e.g., optimal estimate 615) corresponding to the optimal asset. The optimal estimate 615 can include an optimal five year estimate indicative of the five year depreciation percentage for the optimal asset and/or an optimal fifteen year estimate indicative of the fifteen year depreciation percentage for the optimal asset. The depreciation system 175 can generate the holistic cost segregation estimate 620 based, at least in part, on the optimal depreciation data (e.g., estimate 615). For example, the depreciation system 175 can determine the holistic depreciation data (e.g., estimate 620) based on the use depreciation data (e.g., use classification estimate 605), the group depreciation data (e.g., group classification estimate 610), and/or the optimal depreciation data (e.g., optimal estimate 615).

By way of example, in the event that the asset profile 210 includes a use classification and a group classification and the subset of assets associated with the use classification include one or more assets associated with one or more cost segregation studies and/or estimates from the historical database 140, the depreciation system 175 can determine the holistic depreciation data (e.g., holistic estimate 620) based, at least in part, on an average of the use depreciation data (e.g., use classification estimate 605), the group depreciation data (e.g., group classification estimate 610), and the optimal depreciation data (e.g., optimal estimate 615).

As another example, in the event that the asset profile 210 includes at least a group classification and the subset of assets associated with the group classification include one or more assets associated with one or more cost segregation studies and/or estimates from the historical database 140, the depreciation system 175 can determine the holistic depreciation data (e.g., holistic estimate 620) based, at least in part, on an average of the group depreciation data (e.g., group classification estimate 610), and the optimal depreciation data (e.g., optimal estimate 615). In the event that the subset of assets associated with the group classification and the use classification do not include at least one asset associated with a cost segregation study and/or estimate from the historical database 140, the holistic depreciation data (e.g., holistic estimate 620) can include the group depreciation data (e.g., group classification estimate 610).

Turning back to FIG. 1, the asset management system 150 (e.g., estimation system 170) can determine a cost segregation estimate based, at least in part, on the holistic depreciation data. The cost segregation estimate can be indicative of, for example, the holistic depreciation estimate (e.g., holistic estimate 620 of FIG. 6) for the selected asset 165. For example, the cost segregation estimate can be indicative of a five year depreciation estimate and/or a fifteen year depreciation estimate for the selected asset 165. In addition, or alternatively, the asset management system 150 can determine one or more depreciation schedule(s) (e.g., via the scheduling system 177) and/or a benefit analysis (e.g., via the benefit system 176). The depreciation schedule(s) and/or the benefit analysis can be determined based, at least in part, on the holistic depreciation estimate.

For example, the asset management system 150 (e.g., scheduling system 177) can determine one or more depreciation schedule(s) for the selected asset 165 based, at least in part, on the holistic depreciation data, a residential flag value (e.g., data indicative of whether the selected asset 165 is a residential property or a commercial property), and/or one or more other system configuration parameters (e.g., mid-quarter convention, State tax rate, bonus depreciation value, etc.).

For instance, the scheduling system 177 can determine a default depreciation period in years based on the residential flag value. The default depreciation period in years can include twenty-seven and a half years in the event that the residential flag value for the selected asset 165 is indicative of a residential property. Otherwise, the default depreciation period in years can include thirty-nine years. The scheduling system 177 can determine a five year depreciation schedule (e.g., with a depreciation period in years of five), a fifteen year depreciation schedule (e.g., with a depreciation period in years of fifteen), and/or a default depreciation schedule (e.g., with a depreciation period in years of 27½ or 39).

To do so, the scheduling system 177 can determine a depreciation rate for each of the depreciation schedules. For instance, the five year depreciation schedule rate can be 2/the depreciation period in years (e.g., 5). The fifteen year depreciation schedule rate can be 3/2*the depreciation period in years (e.g., 15). And, the default depreciation schedule can be 1/the depreciation period in years (e.g., 27½ or 39).

The scheduling system 177 can determine a first year portion for the five year and fifteen year depreciation schedules based on the place in service date. For instance, the first year portion of the five year depreciation schedule can be 0.5 in the event that the mid quarter convention if false and the month of the place in service date is between January and September. The first year portion of the five year depreciation schedule can be 0.25 in the event that the mid quarter convention is false and the place in service date is between October and December. In addition, or alternatively, the first year portion of the fifteen year depreciation schedule can be 0.375 in the event that the mid quarter convention if false and the month of the place in service date is between January and September and 0.125 in the event that the mid quarter convention is false and the place in service date is between October and December. The first year portion of the default depreciation schedule can be: (25−(2*Month Number of the Place in Service Data))/24.

The scheduling system 177 can determine a first year depreciation percentage for each of the depreciation schedules. For instance, if the bonus depreciation is 50%, the respective first year percentage (e.g., first year percentage of the five year depreciation schedule, the first year percentage of the fifteen year depreciation schedule, etc.) can be 50%+(50%*respective depreciation rate*respective first year portion of the respective depreciation schedule (e.g., five year, fifteen year, etc.)). The respective first year percentage for the default depreciation schedule can be the depreciation rate*the first year portion. The first year cumulative depreciation percentage for each of the depreciation schedules can be the respective first year percentage.

The scheduling system 177 can determine a yearly depreciation percentage for each year of each of the depreciation schedules (e.g., five years for the five year depreciation schedule, fifteen years for the fifteen year depreciation schedule, period in years (e.g., 27½, 39) for the default depreciation schedule, etc.). To do so, the scheduling system 177 can determine a percentage remaining by subtracting the cumulative percentage for the previous year from 100%. For example, the second year's percentage remaining can include 100%−the respective first year percentage of a respective depreciation schedule. The third year percentage remaining can include 100%−the respective first year percentage and the respective second year percentage for the respective depreciation schedule, etc.

For each year of each respective depreciation schedule, the scheduling system 177 can determine a respective yearly depreciation rate. For instance, the five year depreciation schedule yearly depreciation rate of a respective year can be the max value between 2/the depreciation period in years (e.g., 5) and 1/(the depreciation period in years (e.g., 5)−the first year portion+2−the respective year). The fifteen year depreciation schedule yearly depreciation rate for a respective year can be the max value between 3/(2*the depreciation period in years (e.g., 15)) and 1/(the depreciation period in years (e.g., 15)−the first year portion+2−the respective year). The default depreciation schedule yearly depreciation rate of a respective year can be 1/(depreciation period in years (e.g., 27½, 39, etc.)+2−the respective year).

The scheduling system 177 can determine a yearly portion for each respective year of each of the depreciation schedules. The yearly portion for a respective year can be the depreciation period of years (e.g., 5, 15, 27½, 39, etc.)−the first year portion+2−the respective year. If the yearly portion for the respective year is less than zero it can be set to zero. If the yearly portion for the respective year is greater than one it can be set to 1. The scheduling system 177 can determine a depreciation percentage for the respective year by multiplying the percentage remaining for the respective year with the yearly depreciation rate and the yearly portion of the respective year (e.g., percentage remaining*yearly depreciation rate for the respective year*yearly portion for the respective year). The cumulative percentage for the respective year can be the cumulative sum of the first year depreciation rate and each yearly depreciation rate for each year preceding the respective year. The scheduling system 177 can determine a depreciation rate for each year of each of the depreciation schedules.

In this manner, the scheduling system 177 can generate one or more depreciation schedules for the selected asset 165, each depreciation schedule identifying a depreciation percentage for the selected asset 165 for each year of the depreciation schedule. In some implementations, the holistic cost segregation estimate can include one or more of the cost segregation schedule(s). In addition, or alternatively, the one or more cost segregation schedule(s) can be utilized to generate a benefit analysis for the selected asset 165.

For example, the asset management system 150 (e.g., benefit system 176) can generate a benefit analysis for the selected asset 165 based, at least in part, on a place in service date, a purchase price, a holistic depreciation estimate (e.g., average five year depreciation percentage, average fifteen year depreciation percentage, etc.), a leasehold value, and/or the one or more depreciation schedule(s). To do so, the benefit system 176 can determine a new average five year depreciation percentage and a new fifteen year depreciation percentage for the selected asset 165. The new five year average depreciation percentage can be the average five year depreciation percentage minus 0.02. In the event that the selected asset 165 is a leasehold (e.g., as indicated by the leasehold value), the new fifteen year average depreciation percentage can be 1−the new five year average depreciation percentage. In the event that the selected asset 165 is not a leasehold (e.g., as indicated by the leasehold value), the new fifteen year average depreciation percentage can be the average fifteen year depreciation percentage minus 0.02.

The benefit system 176 can determine a five year depreciable basis, a fifteen year depreciable basis, and a default depreciable basis for the selected asset 165. The five year depreciable basis can be the new five year average depreciation percentage*the purchase price of the selected asset 165. The fifteen year depreciable basis can be the new fifteen year average depreciation percentage*the purchase price of the selected asset 165. And, the default depreciable basis can be the purchase price−the five year average depreciable basis−the fifteen year average depreciable basis.

The benefit system 176 can generate a benefit analysis for the selected asset 165 for 40 years after the place in service year of the selected asset 165. The benefit analysis can include a five year depreciation, a fifteen year depreciation, a depreciation default, a total depreciation after a cost segregation analysis, a total depreciation without a cost segregation analysis, and a timing benefit for utilizing a cost segregation analysis. The five year depreciation (e.g., an amount depreciated over five years) can be the five year depreciable basis*the depreciation rate for a respective year of the five year depreciation schedule (e.g., from the five year depreciation schedule). The fifteen year depreciation (e.g., an amount depreciated over fifteen years) can be the fifteen year depreciable basis*the depreciation rate for a respective year of the fifteen year depreciation schedule (e.g., from the fifteen year depreciation schedule). The default depreciation (e.g., a default amount depreciated over the period in years) can be the default depreciable basis*the depreciation rate for a respective year of the default depreciation schedule (e.g., from the default depreciation schedule).

The benefit system 176 can determine the total depreciation after the cost segregation analysis for a respective year by adding the five year depreciation, the fifteen year depreciation, and the default depreciation for the respective year. The benefit system 176 can determine the total depreciation without the cost segregation analysis by multiplying the purchase price by the depreciation rate for a respective year of the default depreciation schedule (e.g., from the default depreciation schedule). The benefit system 176 can determine the yearly timing benefit for utilizing a cost segregation analysis by subtracting the total depreciation without the cost segregation analysis from the total depreciation after the cost segregation analysis for a respective year. The benefit system 176 can determine a cumulative benefit by aggregating (e.g., adding) the yearly timing benefit for each respective year for 40 years.

The asset management system 150 can determine a first year depreciation difference for the selected asset 165 based, at least in part, on the benefit analysis that corresponds to the place in service date year for the selected asset 165. The asset management system 150 can determine an estimated first year cash benefit for the selected asset by multiplying the first year depreciation difference with an estimated marginal tax rate (e.g., the Federal tax rate+State tax rate) for the selected asset 165.

The asset management system 150 can determine the accumulated five year cash benefit for the selected asset 165. To do so, the asset management system 150 can determine a net profit value (“NPV”) for the years 2-5. The second year net profit value, for example, can be: 1/(1+the NPV discount factor). The third year net profit value can be: second year NPV/1+NPV discount factor). The fourth year net profit value can be: third year NPV/1+NPV discount factor). And, the fifth year net profit value can be: fourth year NPV/1+NPV discount factor). The asset management system 150 can determine the year benefit by multiplying each respective year's net profit value with the corresponding timing difference from the benefit analysis. The accumulated five year cash benefit for the selected asset 165 can be the sum of all first five year benefits.

The asset management system 150 can store the holistic cost segregation estimate and/or one or more components thereof (e.g., the holistic depreciation data, the one or more cost segregation schedules, the benefit analysis, the accumulated five year benefit, etc.) for the selected asset 165 in the historical database 140. By doing so, the holistic cost segregation estimates generated by the asset management system 150 can be used to determine subsequent cost segregation estimates. In this manner, the asset management system 150 can generate more robust and accurate cost segregation estimates over time. In some implementations, the stored cost segregation estimates can be verified by a cost segregation study (e.g., a real cost segregation study performed for the respective asset). In such a case, the asset management system can prioritize (e.g., via a weighting scheme) verified cost segregation estimates over unverified cost segregation estimates while generating a new cost segregation estimate.

The asset management system 150 can provide for display to a user (e.g., via the display device(s) 110) the holistic cost segregation estimate and/or one or more components thereof (e.g., a holistic depreciation estimate, a benefit analysis, one or more cost segregation schedule(s), etc.) to the user 105. By way of example, in response to the user input (e.g., selection user input, user profile input, etc.), the asset management system can provide for display to the user 105 a user interface presenting at least one of the asset profile, the holistic cost segregation estimate (one or more components of the cost segregation estimate), etc. for the selected asset 165. By way of example, the cost segregation estimate can be calculated automatically when the selected asset 165 (e.g., a property) is added to a personal and/or commercial user profile and/or identified in any other manner. After that the user 105 can have the ability to generate new estimates and/or delete existing estimates for the select asset 165 via one or more of the techniques described herein.

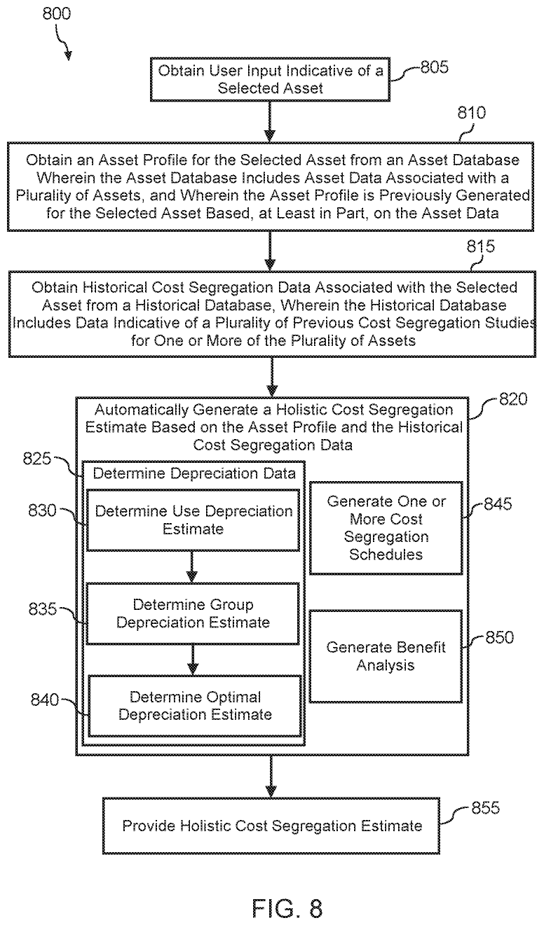

FIG. 8 depicts an example method for automatically generating a cost segregation estimate according to example embodiments of the present disclosure. The method 800 can be implemented, for instance, using one or more computing device(s) (e.g., computing device(s) 105), the asset management system 150 and/or any of the one or more portions of the asset management system 150 (e.g., estimation system 170, search system 160, user profile system 180, etc.) of the computing system 100 of FIG. 1. Moreover, one or more portion(s) of the method 800 can be implemented as an algorithm on the hardware components of the device(s) described herein (e.g., as in FIGS. 1, 3A-5, and 9) to, for example, automatically generate and display cost segregation analysis. FIG. 8 depicts steps performed in a particular order for purposes of illustration and discussion. Those of ordinary skill in the art, using the disclosure provided herein, will understand that various steps of any of the methods described herein can be omitted, expanded to include other steps, performed simultaneously, rearranged, and/or modified in various ways without deviating from the scope of the present disclosure.

At (805), the method 800 can include obtaining user input indicative of a selected asset. For instance, a computing system (e.g., asset management system 150, search system 160, etc.) can obtain user input indicative of a selection from the user. For example, the computing system can obtain user input indicative of a selected asset from a user. The user input can include selection user input indicative of the selected asset. By way of example, the computing system can provide for display to the user a first user interface presenting one or more of a plurality of assets for selection by the user. The selection user input can be indicative of a selected asset from the one or more presented assets.

In some implementations, the computing system can provide for display to the user a preceding user interface (e.g., a user interface preceding the selection user input) presenting one or more search criteria options. The computing system can obtain, via the preceding user interface, query user input indicative of search criteria for the one or more of the plurality of assets. The search criteria can be indicative of one or more asset attributes. In such a case, the computing system can identify the one or more of the plurality of assets based, at least in part, on the search criteria selected by the user. The one or more of the plurality of assets, for example, can be associated with the one or more asset attributes. The search criteria, for example, can include at least one of location data, ownership data, price data, a group classification, a use classification, a footprint, and/or depreciation data.

In some implementations, the computing system can provide for display to the user a subsequent user interface (e.g., a user interface subsequent to the selection user input) presenting one or more user profile options for selection by the user. The computing system can obtain, via the subsequent user interface, user profile input indicative of a user profile option. The user profile option can be indicative of adding the selected asset to a user profile.

At (810), the method 800 can include obtaining an asset profile for the selected asset from an asset database, wherein the asset database includes asset data associated with a plurality of assets, and wherein the asset profile is previously generated for the selected asset based on the asset data. For instance, a computing system (e.g., asset management system 150, estimation system 170, etc.) can obtain an asset profile for the selected asset from an asset database. The asset database can include asset data associated with a plurality of assets. The asset profile can be previously generated for the selected asset based on the asset data.

The asset profile can include one or more asset attributes corresponding to the selected asset. As an example, the asset profile can include one or more asset attributes indicative of at least one of the location data, ownership data, price data, group classification, use classification, footprint, and/or depreciation data. For instance, the asset data corresponding the selected asset can include a plurality of asset attributes corresponding the selected asset. Previously generating the asset profile for the selected asset can include assigning a confidence score to each of the plurality of asset attributes corresponding to the selected asset and generating the asset profile for the selected asset based on the confidence score for each of the plurality of asset attributes corresponding to the selected asset. For example, the asset profile for the selected asset can include one or more asset attributes associated with a respective confidence score above a confidence threshold.

At (815) the method 800 can include obtaining historical cost segregation data associated with the selected asset from a historical database, wherein the historical database includes data indicative of a plurality of previous cost segregation studies for one or more of the plurality of assets. For instance, a computing system (e.g., asset management system 150, estimation system 170, etc.) can obtain the historical cost segregation data associated with the selected asset from the historical database. The historical cost segregation database can include data indicative of a plurality of previous cost segregation studies for one or more of the plurality of assets.

At (820), the method 800 can include automatically generating a holistic cost segregation estimate for the selected asset based on the asset profile and the historical cost segregation data. For instance, a computing system (e.g., asset management system 150, estimation system 170, etc.) can automatically generate a holistic cost segregation estimate for the selected asset based on the asset profile and the historical cost segregation data. The holistic cost segregation estimate can include holistic depreciation data, one or more cost segregation schedules, and/or a benefit analysis for the selected asset. The computing system can automatically generate the holistic cost segregation estimate for the selected asset in response to the selection user input and/or the user profile user input.

At (825), to generate the holistic cost segregation estimate, the method 800 can include determining the holistic depreciation data. For instance, a computing system (e.g., asset management system 150, estimation system 170, etc.) can generate the holistic depreciation data. The holistic depreciation data can be an average of at least one of use depreciation data, a group depreciation data, and/or an optimal depreciation data. For instance, the computing system can determine the holistic deprecation data based, at least in part, on the average of the use depreciation data, the group depreciation data, and the optimal depreciation data. The holistic depreciation data can include a five year depreciation average and a fifteen year depreciation average for the selected asset.

At (830), to determine the holistic depreciation data, the method can include determining use depreciation data. For instance, a computing system (e.g., asset management system 150, estimation system 170, etc.) can determine the use depreciation data. For example, the one or more asset attributes can include a use classification. The computing system can determine the use depreciation data for the asset based, at least in part, on the use classification and the historical cost segregation data. The computing system can generate the holistic cost segregation estimate based, at least in part, on the use depreciation data.

At (835), to determine the holistic depreciation data, the method can include determining group depreciation data. For instance, a computing system (e.g., asset management system 150, estimation system 170, etc.) can determine the group depreciation data. For example, the one or more attributes of the asset profile can include an asset group classification. By way of example, previously generating the asset profile for the selected asset can include determining the asset group classification for the selected asst base on the one or more asset attributes corresponding to the selected asset. The asset group classification can identify a respective asset group of a plurality of predefined asset groups. Each of the plurality of predefined asset groups can be indicative of an association between one or more use classifications. The computing system can determine the group depreciation data for the asset based on the asset group classification and the historical cost segregation data. The computing system can generate the holistic cost segregation estimate based on the group depreciation data.

At (840), to determine the holistic depreciation data, the method can include determining optimal depreciation data. For instance, a computing system (e.g., asset management system 150, estimation system 170, etc.) can determine the optimal depreciation data. For example, the computing system can determine an optimal asset for the selected asset based, at least in part, on the asset profile. The computing system can determine the optimal depreciation data corresponding to the optimal asset. And, the computing system can generate the holistic cost segregation estimate based, at least in part, on the optimal depreciation data.

By way of example, the one or more asset attributes can include a purchase price and an asset footprint indicative of at least one of a building size or a lot size. The computing system can determine a similarity value for each of a subset of assets of the asset database based, at least in part, on a comparison between the purchase price or the asset footprint corresponding to the selected asset and a respective purchase price or asset footprint corresponding to each respective asset of subset of assets. The computing system can determine the optimal asset from the subset of assets based, at least in part, on the similarity value for each of the subset of assets.

At (845), to determine the holistic cost segregation estimate, the method 800 can include generating one or more cost segregation schedules. For instance, a computing system (e.g., asset management system 150, estimation system 170, etc.) can generate the one or more cost segregation schedules based, at least in part, on the holistic depreciation data. At (850), to determine the holistic cost segregation estimate, the method 800 can include generating a benefit analysis. For instance, a computing system (e.g., asset management system 150, estimation system 170, etc.) can generate the benefit analysis based, at least in part, on the one or more cost segregation schedules.

At (855), the method 800 can include providing the holistic cost segregation estimate and/or one or more portions thereof to one or more user. For instance, a computing system (e.g., asset management system 150, estimation system 170, etc.) can provide the holistic cost segregation estimate and/or one or more portions thereof to the one or more user(s). For example, the computing system can provide for display to the user(s), the holistic cost segregation estimate. By way of example, the computing system can provide for display to the user a user interface presenting at least one of the asset profile and/or the holistic cost segregation estimate for the selected asset. The computing system can provide the user interface in response to the selection user input and/or the user profile input. In some implementations, the user interface can further present at least one of a respective asset profile or a respective holistic cost segregation estimate for the selected asset and each of a plurality of previously selected assets.

In addition, or alternatively, the computing system can store, in an accessible memory, data indicative of the asset and the cost segregation estimate. For example, the computing system can store the holistic cost segregation estimate in the historical database.

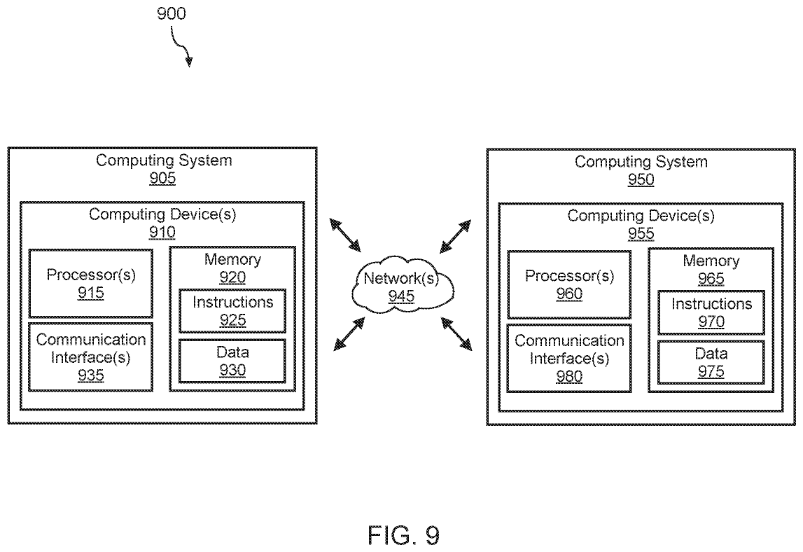

FIG. 9 depicts an example computing system 900 that can be used to implement the systems and methods for automatically generating a cost segregation estimate according to example embodiments of the present disclosure. The example system 900 can include the computing system 905 (e.g., asset management system 150, etc.) and the computing system 950 (e.g., one or more external sources 115, one or more display devices 110, etc.), etc. that are communicatively coupled over one or more network(s) 945.

The computing system 905 can include one or more computing device(s) 910 (e.g., computing devices 105, etc.). The computing device(s) 910 of the computing system 905 can include processor(s) 915 and a memory 920. The one or more processors 915 can be any suitable processing device (e.g., a processor core, a microprocessor, an ASIC, a FPGA, a controller, a microcontroller, etc.) and can be one processor or a plurality of processors that are operatively connected. The memory 920 can include one or more non-transitory computer-readable storage media, such as RAM, ROM, EEPROM, EPROM, one or more memory devices, flash memory devices, etc., and combinations thereof.

The memory 920 can store information that can be accessed by the one or more processors 915. For instance, the memory 920 (e.g., one or more non-transitory computer-readable storage mediums, memory devices) can include computer-readable instructions 925 that can be executed by the one or more processors 915. The instructions 925 can be software written in any suitable programming language or can be implemented in hardware. Additionally, or alternatively, the instructions 925 can be executed in logically and/or virtually separate threads on processor(s) 915.

For example, the memory 920 can store instructions 925 that when executed by the one or more processors 915 cause the one or more processors 1015 to perform operations such as any of the operations and functions for which the computing systems are configured, as described herein.

The memory 920 can store data 930 that can be obtained, received, accessed, written, manipulated, created, and/or stored. The data 930 can include, for instance, the asset database, historical database, asset data, asset profiles, historical data, etc. as described herein. In some implementations, the computing device(s) 910 can obtain from and/or store data in one or more memory device(s) that are remote from the computing system 905 such as one or more memory devices of the computing system 950.

The computing device(s) 910 can also include a communication interface 935 used to communicate with one or more other system(s) (e.g., computing system 950). The communication interface 935 can include any circuits, components, software, etc. for communicating via one or more networks (e.g., 945). In some implementations, the communication interface 935 can include for example, one or more of a communications controller, receiver, transceiver, transmitter, port, conductors, software and/or hardware for communicating data/information.

The computing system 950 can include one or more computing devices 955. The one or more computing devices 955 can include one or more processors 960 and a memory 965. The one or more processors 960 can be any suitable processing device (e.g., a processor core, a microprocessor, an ASIC, a FPGA, a controller, a microcontroller, etc.) and can be one processor or a plurality of processors that are operatively connected. The memory 965 can include one or more non-transitory computer-readable storage media, such as RAM, ROM, EEPROM, EPROM, one or more memory devices, flash memory devices, etc., and combinations thereof.

The memory 965 can store information that can be accessed by the one or more processors 960. For instance, the memory 965 (e.g., one or more non-transitory computer-readable storage mediums, memory devices) can store data 975 that can be obtained, received, accessed, written, manipulated, created, and/or stored. The data 975 can include, for instance, asset data, and/or other data or information described herein. In some implementations, the computing system 950 can obtain data from one or more memory device(s) that are remote from the computing system 950.

The memory 965 can also store computer-readable instructions 970 that can be executed by the one or more processors 960. The instructions 970 can be software written in any suitable programming language or can be implemented in hardware. Additionally, or alternatively, the instructions 970 can be executed in logically and/or virtually separate threads on processor(s) 960. For example, the memory 965 can store instructions 970 that when executed by the one or more processors 960 cause the one or more processors 960 to perform any of the operations and/or functions described herein, including, for example, any of the operations and functions of the devices described herein, and/or other operations and functions.

The computing device(s) 955 can also include a communication interface 980 used to communicate with one or more other system(s). The communication interface 980 can include any circuits, components, software, etc. for communicating via one or more networks (e.g., 945). In some implementations, the communication interface 980 can include for example, one or more of a communications controller, receiver, transceiver, transmitter, port, conductors, software and/or hardware for communicating data/information.

The network(s) 945 can be any type of network or combination of networks that allows for communication between devices. In some embodiments, the network(s) 945 can include one or more of a local area network, wide area network, the Internet, secure network, cellular network, mesh network, peer-to-peer communication link and/or some combination thereof and can include any number of wired or wireless links. Communication over the network(s) 945 can be accomplished, for instance, via a network interface using any type of protocol, protection scheme, encoding, format, packaging, etc.

The technology discussed herein makes reference to servers, databases, software applications, and other computer-based systems, as well as actions taken, and information sent to and from such systems. One of ordinary skill in the art will recognize that the inherent flexibility of computer-based systems allows for a great variety of possible configurations, combinations, and divisions of tasks and functionality between and among components. For instance, server processes discussed herein can be implemented using a single server or multiple servers working in combination. Databases and applications can be implemented on a single system or distributed across multiple systems. Distributed components can operate sequentially or in parallel. Furthermore, computing tasks discussed herein as being performed at a server can instead be performed at a user device.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method, comprising:
obtaining, by a computing system comprising one or more computing devices, user input indicative of a selected asset from a user;
obtaining, by the computing system, an asset profile for the selected asset from an asset database, wherein the asset database comprises asset data associated with a plurality of assets, and wherein the asset profile is previously generated for the selected asset based, at least in part, in the asset data;
obtaining, by the computing system, historical segregation data associated with the selected asset from a historical database, wherein the historical database comprises data indicative of a plurality of previous segregation studies for one or more of the plurality of assets;
automatically generating, by the computing system, a holistic segregation estimate for the selected asset based, at least in part, on the asset profile and the historical segregation data; and
providing for display to the user, by the computing system, the holistic segregation estimate.

2. The computer-implemented method of claim 1, wherein the asset profile comprises one or more asset attributes corresponding to the selected asset, wherein the one or more asset attributes comprise a use classification, and wherein generating the holistic segregation estimate comprises:
determining, by the computing system, use depreciation data for the asset based, at least in part, on the use classification and the historical segregation data; and
generating, by the computing system, the holistic segregation estimate based, at least in part, on the use depreciation data.

3. The computer-implemented method of claim 2, wherein the asset profile comprises one or more asset attributes corresponding to the selected asset, wherein the one or more attributes comprise an asset group classification, and wherein generating the holistic segregation estimate comprises:
determining, by the computing system, group depreciation data for the asset based, at least in part, on the asset group classification and the historical segregation data; and
generating, by the computing system, the holistic segregation estimate based, at least in part, on the group depreciation data.

4. The computer-implemented method of claim 3, wherein the asset group classification identifies a respective asset group of a plurality of predefined asset groups, wherein each of the plurality of predefined asset groups is indicative of an association between one or more use classifications.

5. The computer-implemented method of claim 3, wherein previously generating the asset profile for the selected asset comprises:
determining, by the computing system, the asset group classification for the selected asset based, at least in part, on the one or more asset attributes corresponding to the selected asset.

6. The computer-implemented method of claim 3, wherein generating the holistic segregation estimate comprises:
determining, by the computing system, an optimal asset for the selected asset based, at least in part, on the asset profile;
determining, by the computing system, optimal depreciation data corresponding to the optimal asset; and
generating, by the computing system, the holistic segregation estimate based, at least in part, on the optimal depreciation data.

7. The computer-implemented method of claim 6, wherein the holistic segregation estimate comprises holistic depreciation data, and wherein generating the holistic segregation estimate comprises:
determining, by the computing system, the holistic depreciation data based, at least in part, on an average of the use depreciation data, the group depreciation data, and the optimal depreciation data.

8. The computer-implemented method of claim 7, wherein the holistic depreciation data comprises a five year depreciation average and a fifteen year depreciation average for the selected asset.

9. The computer-implemented method of claim 6, wherein the one or more asset attributes comprise a purchase price and an asset footprint indicative of at least one of a building size or a lot size, and wherein determining the optimal asset comprises:
determining, by the computing system, a similarity value for each of a subset of assets of the asset database based, at least in part, on a comparison between the purchase price or the asset footprint corresponding to the selected asset and a respective purchase price or asset footprint corresponding to each respective asset of subset of assets; and
determining, by the computing system, the optimal asset from the subset of assets based, at least in part, on the similarity value for each of the subset of assets.

10. A computer-implemented method of claim 1, further comprising:
storing, by the computing system, the holistic segregation estimate in the historical database.

11. A computing system comprising:
an asset database comprising asset data associated with a plurality of assets;
a historical database comprising historical segregation data indicative of a plurality of previous segregation studies for one or more of the plurality of assets;
one or more display devices;
one or more processors; and
one or more non-transitory computer-readable media that collectively store instructions that, when executed by the one or more processors, cause the system to perform operations, the operations comprising:
providing for display to a user, via the one or more display devices, a first user interface presenting one or more of the plurality of assets for selection by the user;
obtaining, via the first user interface, a selection user input indicative of a selected asset;
obtaining an asset profile for the selected asset from the asset database, wherein the asset profile is previously generated based, at least in part, on a portion of the asset data corresponding to the selected asset; and
in response to the selection user input:
automatically generating a holistic segregation estimate for the selected asset based, at least in part, on the asset profile for the selected asset and the historical segregation data; and
providing for display to the user, via the one or more display devices, a second user interface presenting at least one of the asset profile or the holistic segregation estimate for the selected asset.

12. The computing system of claim 11, wherein the operations further comprise:
providing for display to the user, via the one or more display devices, a third user interface presenting one or more search criteria options;
obtaining, via the third user interface, query user input indicative of search criteria for the one or more of the plurality of assets; and
identifying the one or more of the plurality of assets based, at least in part, on the search criteria.

13. The computing system of claim 12, wherein the search criteria comprises at least one of location data, ownership data, price data, a group classification, a use classification, a footprint, or depreciation data.

14. The computing system of claim 13, wherein the asset profile comprises one or more asset attributes indicative of at least one of the location data, ownership data, price data, group classification, use classification, footprint, or depreciation data.

15. The computing system of claim 11, wherein the asset data corresponding the selected asset comprises a plurality of asset attributes corresponding the selected asset, and wherein previously generating the asset profile for the selected asset comprises:
assigning a confidence score to each of the plurality of asset attributes corresponding to the selected asset; and
generating the asset profile for the selected asset based, at least in part, on the confidence score for each of the plurality of asset attributes corresponding to the selected asset, wherein the asset profile for the selected asset comprises one or more asset attributes associated with a respective confidence score above a confidence threshold.

16. The computing system of claim 11, wherein the operations further comprise:
in response to the selection user input:
providing for display to a user, via the one or more display devices, a fourth user interface presenting one or more user profile options for selection by the user;
obtaining, via the fourth user interface, user profile input indicative of a user profile option, wherein the user profile option is indicative of adding the selected asset to a user profile.

17. The computing system of claim 16, wherein the operations further comprise:
generating the holistic segregation estimate for the selected asset and providing for display to the user, via the one or more display devices, the second user interface in response to the user profile input.

18. The computing system of claim 17, wherein the second user interface presents at least one of a respective asset profile or a respective holistic segregation estimate for the selected asset and each of a plurality of previously selected assets.

19. A computer-implemented method comprising:
obtaining, by a computing system comprising one or more computing devices, search criteria indicative of one or more asset attributes;
providing for display, by the computing system via one or more display devices, a first user interface presenting a visual representation of a plurality of assets for selection by a user, wherein each of the plurality of assets are associated with the one or more asset attributes;
obtaining, by the computing system via the first user interface, selection user input selecting an asset from the plurality of assets;
in response to the selection user input, automatically generating, by the computing system, a segregation estimate for the asset; and
storing, by the computing system in an accessible memory, data indicative of the asset and the segregation estimate.

20. The computer-implemented method of claim 19, wherein the accessible memory comprises a historical database comprising historical segregation data indicative of a plurality of previous segregation studies for one or more of the plurality of assets, and wherein the segregation estimate for the asset is automatically generated based, at least in part, on the historical segregation data.
